(19) United States
(12) Patent Application Publication
(10) Pub. No.: US 2026/0203621 A1
(43) Pub. Date: Jul. 16, 2026

(54) INFORMATION PROCESSING APPARATUS, ANALYSIS ASSISTANCE METHOD, AND STORAGE MEDIUM

(71) Applicant: NEC Corporation, Tokyo (JP)

(72) Inventors: Katsuya HAYAMI, Tokyo (JP); Masaki KOIZUMI, Tokyo (JP); Kenta KASAHARA, Tokyo (JP)

(73) Assignee: NEC Corporation, Tokyo (JP)

(21) Appl. No.: 19/138,189

(22) PCT Filed: Dec. 21, 2022
(86) PCT No.: PCT/JP2022/047046

§ 371 Date: Jun. 12, 2025

(51) Int. Cl. G06N 7/01

(52) U.S. Cl. CPC G06N 7/01

(57) ABSTRACT

In order to allow a user to easily recognize an analysis result of causal analysis, an information processing apparatus (1) includes: a reception section (11) for receiving designate of an element which has been subjected to causal analysis; a path detection section (12) for detecting a path including a designated element from among paths each constituted by a plurality of elements connected to each other by a causal relationship; and a display control section (13) for causing, in a case where a plurality of paths sharing an end point element have been detected, path information to be displayed which indicates each of the paths in a mode corresponding to that path.

### TECHNICAL FIELD

The present invention relates to an information processing apparatus and the like that carry out processes related to causal analysis.

### BACKGROUND ART

Conventionally, a method of causal analysis has been known in which causal relationships existing between a plurality of elements are found from pieces of data related to the respective plurality of elements. For example, Patent Literature 1 below discloses constructing a directed acyclic graph which expresses a relationship between a plurality of variables and target results. Patent Literature 1 also indicates that a constructed directed acyclic graph is used to analyze whether or not there is sufficient causal evidence for identifying a causal relationship between a variable of interest and a target result.

### CITATION LIST

### Patent Literature

### [Patent Literature 1]

Japanese Patent Application Publication Tokukai No. 2019-194849

### SUMMARY OF INVENTION

### Technical Problem

The above described related art has room for improvement in allowing a user to more easily recognize an analysis result of causal analysis. That is, a directed acyclic graph represents elements by respective nodes and indicates causal relationships thereof by directed edges. Thus, the directed acyclic graph is intuitively understandable. However, in a case where the number of elements increases, an appearance of the directed acyclic graph becomes complicated. It is difficult to quickly recognize, from a complicated directed acyclic graph, information which a user wants to know.

An example object of an example aspect of the present invention is to implement an information processing apparatus and the like which can allow a user to more easily recognize an analysis result of causal analysis.

### Solution to Problem

An information processing apparatus in accordance with an example aspect of the present invention includes: a reception means for receiving designation of at least one element from among a plurality of elements which have been subjected to causal analysis; a path detection means for detecting a path including a designated element from among paths each constituted by a plurality of elements that are connected to each other by a causal relationship; and a display control means for causing, in a case where the path detection means has detected a plurality of paths which share an element serving as an end point, path information to be displayed which indicates each of the plurality of paths in a mode corresponding to that path.

An analysis assistance method in accordance with an example aspect of the present invention includes: receiving, by at least one processor, designation of at least one element from among a plurality of elements which have been subjected to causal analysis; detecting, by the at least one processor, a path including a designated element from among paths each constituted by a plurality of elements that are connected to each other by a causal relationship; and causing, by the at least one processor, path information to be displayed in a case where a plurality of paths which share an element serving as an end point have been detected, the path information indicating each of the plurality of paths in a mode corresponding to that path.

An analysis assistance program in accordance with an example aspect of the present invention causes a computer to function as: a reception means for receiving designation of at least one element from among a plurality of elements which have been subjected to causal analysis; a path detection means for detecting a path including a designated element from among paths each constituted by a plurality of elements that are connected to each other by a causal relationship; and a display control means for causing, in a case where the path detection means has detected a plurality of paths which share an element serving as an end point, path information to be displayed which indicates each of the plurality of paths in a mode corresponding to that path.

### Advantageous Effects of Invention

According to an example aspect of the present invention, it is possible to allow a user to more easily recognize an analysis result of causal analysis.

### BRIEF DESCRIPTION OF DRAWINGS

FIG. 1 is a block diagram illustrating a configuration of an information processing apparatus in accordance with a first example embodiment of the present invention.

FIG. 2 is a flowchart illustrating a flow of an analysis assistance method in accordance with the first example embodiment of the present invention.

FIG. 3 is a block diagram illustrating a configuration of an information processing apparatus in accordance with a second example embodiment of the present invention.

FIG. 4 is a diagram illustrating an example of designation of an element and detection of a path.

FIG. 5 is a diagram illustrating a path information display screen example.

FIG. 6 is a diagram illustrating another path information display screen example.

FIG. 7 is a diagram illustrating still another path information display screen example.

FIG. 8 is a diagram illustrating yet another path information display screen example.

FIG. 9 is a flowchart illustrating a flow of an analysis assistance method in accordance with the second example embodiment of the present invention.

FIG. 10 is a diagram illustrating an example of a computer which executes instructions of a program that is software realizing functions of the apparatus in accordance with each of example embodiments of the present invention.

### EXAMPLE EMBODIMENTS

### First Example Embodiment

The following description will discuss a first example embodiment of the present invention in detail, with reference to the drawings. The present example embodiment is a basic form of example embodiments described later.

### (Configuration of Information Processing Apparatus)

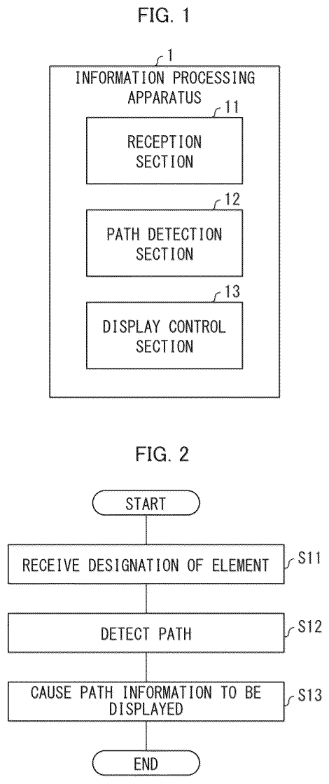

The following description will discuss a configuration of an information processing apparatus 1 in accordance with the present example embodiment, with reference to FIG. 1. FIG. 1 is a block diagram illustrating the configuration of the information processing apparatus 1. As illustrated in FIG. 1, the information processing apparatus 1 includes a reception section 11, a path detection section 12, and a display control section 13.

The reception section 11 receives designation of at least one element from among a plurality of elements which have been subjected to causal analysis.

The path detection section 12 detects a path including a designated element from among paths each constituted by a plurality of elements that are connected to each other by a causal relationship.

In a case where the path detection section 12 has detected a plurality of paths which share an element serving as an end point, the display control section 13 causes path information to be displayed which indicates each of the plurality of paths in a mode corresponding to that path.

As described above, the information processing apparatus 1 in accordance with the present example embodiment employs the configuration of including: the reception section 11 for receiving designation of at least one element from among a plurality of elements which have been subjected to causal analysis; the path detection section 12 for detecting a path including a designated element from among paths each constituted by a plurality of elements that are connected to each other by a causal relationship; and the display control section 13 for causing, in a case where the path detection section 12 has detected a plurality of paths which share an element serving as an end point, path information to be displayed which indicates each of the plurality of paths in a mode corresponding to that path. Therefore, according to the information processing apparatus 1 in accordance with the present example embodiment, it is possible to bring about an example advantage of making it possible to allow a user to more easily recognize an analysis result of causal analysis.

### (Analysis Assistance Program)

The functions of the foregoing information processing apparatus 1 can be implemented also by a program. An analysis assistance program in accordance with the present example embodiment employs the configuration of causing a computer to function as: a reception means for receiving designation of at least one element from among a plurality of elements which have been subjected to causal analysis; a path detection means for detecting a path including a designated element from among paths each constituted by a plurality of elements that are connected to each other by a causal relationship; and a display control means for causing, in a case where the path detection means has detected a plurality of paths which share an element serving as an end point, path information to be displayed which indicates each of the plurality of paths in a mode corresponding to that path. Therefore, according to the analysis assistance program in accordance with the present example embodiment, it is possible to bring about an example advantage of making it possible to allow a user to more easily recognize an analysis result of causal analysis.

(Flow of analysis assistance method)

The following description will discuss a flow of an analysis assistance method in accordance with the present example embodiment, with reference to FIG. 2. FIG. 2 is a flowchart illustrating the flow of the analysis assistance method. Each of the steps in this analysis assistance method may be carried out by a processor included in the information processing apparatus 1 or a processor included in another apparatus. Alternatively, the steps may be carried out by respective processors provided in different apparatuses.

In S11, at least one processor receives designation of at least one element from among a plurality of elements which have been subjected to causal analysis.

In S12, the at least one processor detects a path including the at least one element designated in S11 from among paths each constituted by a plurality of elements that are connected to each other by a causal relationship.

In S13, the at least one processor causes path information to be displayed which indicates the path detected in S12. Here, in a case where a plurality of paths which share an element serving as an end point have been detected in S12, the at least one processor causes, in S13, path information to be displayed which indicates each of the plurality of paths in a mode corresponding to that path.

As described above, the analysis assistance method in accordance with the present example embodiment employs the configuration of including: receiving, by at least one processor, designation of at least one element from among a plurality of elements which have been subjected to causal analysis; detecting, by the at least one processor, a path including a designated element from among paths each constituted by a plurality of elements that are connected to each other by a causal relationship; and causing, by the at least one processor, path information to be displayed in a case where a plurality of paths which share an element serving as an end point have been detected, the path information indicating each of the plurality of paths in a mode corresponding to that path. Therefore, according to the analysis assistance method in accordance with the present example embodiment, it is possible to bring about an example advantage of making it possible to allow a user to more easily recognize an analysis result of causal analysis.

### Second Example Embodiment

### (Configuration of Information Processing Apparatus)

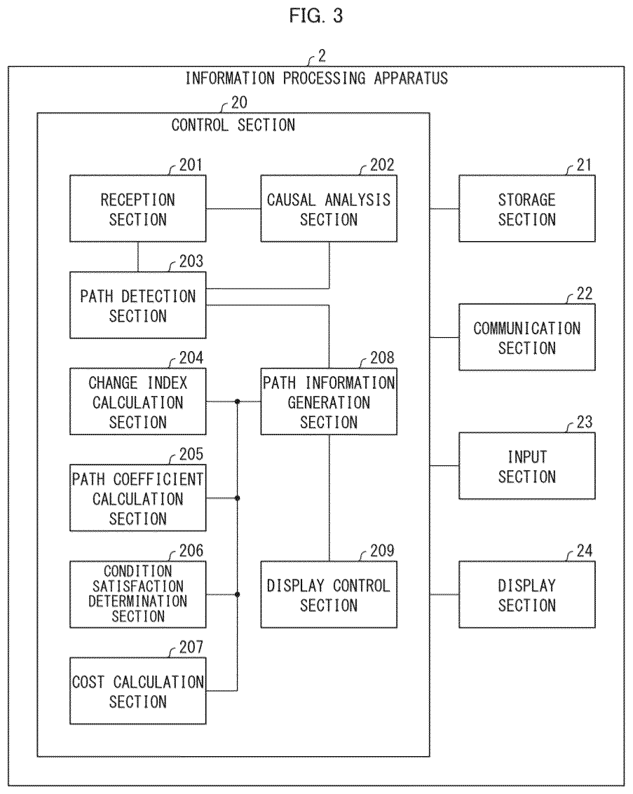

The following description will discuss a configuration of an information processing apparatus 2 in accordance with the present example embodiment, with reference to FIG. 3. FIG. 3 is a block diagram illustrating the configuration of the information processing apparatus 2. As illustrated in FIG. 3, the information processing apparatus 2 includes: a control section 20 that comprehensively controls components of the information processing apparatus 2; and a storage section 21 which stores various kinds of data used by the information processing apparatus 2. Moreover, the information processing apparatus 2 includes: a communication section 22 for allowing the information processing apparatus 2 to communicate with other apparatuses; an input section 23 for receiving input of various kinds of data to the information processing apparatus 2; and a display section 24 for allowing the information processing apparatus 2 to output, by displaying, various kinds of data. Note that the components from the storage section 21 through the display section 24 may be incorporated in the information processing apparatus 2 or may be apparatuses external to the information processing apparatus 2 which are externally connected to the information processing apparatus 2.

The control section 20 includes a reception section 201, a causal analysis section 202, a path detection section 203, a change index calculation section 204, a path coefficient calculation section 205, a condition satisfaction determination section 206, a cost calculation section 207, a path information generation section 208, and a display control section 209.

The reception section 201 receives designation of at least one element from among a plurality of elements which have been subjected to causal analysis by the causal analysis section 202. Note that the “element” will be described in the next paragraph, and designation of an element will be described in the section “Regarding designation of element and detection of path” later.

The causal analysis section 202 carries out causal analysis of a plurality of given elements, and identifies causal structures and causal relationships between those elements. Elements to be subjected to causal analysis are not particularly limited. For example, questions in a questionnaire and answers thereto may be used as elements to be subjected to causal analysis. Alternatively, actions indicated in action history information of a subject or a subject group and a result thereof may be used as elements to be subjected to causal analysis. Data formats of elements may be unified or not unified. The causal analysis section 202 may carry out causal analysis by applying a known causal inference or causal discovery method in accordance with an element of interest or the like.

The following description will discuss an example in which each element is a variable related to a predetermined event. For example, in a case where causal analysis has been carried out on various events related to sale of products, a variable (e.g., a numerical value indicating the number of products purchased, a sales amount, or the like) related to an event in which a product has been purchased can be one element. Moreover, a variable indicating a price of a product, which is related to the above event, can also be an element.

Then, it is possible to predict, by carrying out causal analysis, how a variable of one of elements connected to each other by such a causal relationship changes in a case where a variable of the other element has been changed. For example, in the above example, it is possible to predict the number of products sold in a case where a unit price of the product is reduced by 10% and, conversely, to predict how much the unit price of the product needs to be reduced in order to make the number of products sold equal to or greater than a threshold value. That is, it is possible to identify a relationship between variables where an explanatory variable is a certain variable and an objective variable is another variable which is connected to the certain variable by a causal relationship.

Note that the information processing apparatus 2 does not necessarily need to include the causal analysis section 202. In a case where the causal analysis section 202 is not included, the information processing apparatus 2 may acquire, via the communication section 22 or the input section 23, a result of causal analysis which has been carried out by another apparatus.

The path detection section 203 detects a path including a designated element from among paths each constituted by a plurality of elements that are connected to each other by a causal relationship. The “path” can be, in other words, an element group or an element sequence that is constituted by a plurality of elements which are connected to each other by a causal relationship. Note that designation of an element is received by the reception section 201 as described above. Details of a path detection method will be described in the section “Regarding designation of element and detection of path” later.

Elements which have been subjected to causal analysis can be expressed by a causal graph. In a causal graph, each element is expressed as a “node”, and a causal relationship between elements is expressed as an “edge” connecting nodes. Nodes are classified into a root cause variable (RCV) serving as a start point of a path, a target serving as an end point of a path, and a variable located between an RCV and a target. Therefore, a “path” can be expressed as a path constituted by one or more edges that connect an RCV(s) and a target(s), or as a matrix of nodes from RCVs to targets which are connected to each other by edges. The “path” can be classified into a direct path in which an RCV is directly connected to a target, and an indirect path in which one or more variables are interposed between an RCV and a target.

Note that a target serving as an end point of a path may be referred to as an objective variable, a response variable, a reaction variable, a result variable, a dependent variable, or a non-explanatory variable. An RCV serving as a start point of a path and a variable located between an RCV and a target may be referred to as an explanatory variable, a predictor variable, or an independent variable.

The change index calculation section 204 calculates an index value which indicates a degree to which, in a case where a value (i.e., an RCV) of an element that serves as a start point of a path detected by the path detection section 203 has been changed, a variable of an element (i.e., a target) that serves as an end point of that path changes. This process may be carried out for each of a plurality of paths which are detected by the path detection section 203.

The index value indicating the degree of change may indicate, for example, an amount of change or a rate of change. For example, the change index calculation section 204 may calculate, as the index value, an amount of change in variable of a target in a case where an RCV has been increased by a predetermined amount (e.g., 1). The index value can be calculated based on a product of an amount of change in RCV and a path coefficient (described later). Note that, in a case where there are a plurality of paths, the index value can be calculated by summing products of each amount of change in RCV and a path coefficient of each of the plurality of paths. Similarly, it is possible to calculate a rate of change in variable of a target in a case where an RCV has been increased by a predetermined amount or a predetermined rate.

The index value may indicate a change in statistic. For example, the change index calculation section 204 may calculate the index value which indicates a change in statistic of a variable of a target in a case where an RCV has been increased by a predetermined amount (e.g., 1). The statistic can be, for example, a standard deviation. For example, the change index calculation section 204 may calculate, as the index value, a ratio of a standard deviation of a target variable after a change of an RCV to a standard deviation of a target variable before the change of the RCV. A statistic of interest may be designated by a user.

The path coefficient calculation section 205 calculates a path coefficient for each of paths which are detected by the path detection section 203. The path coefficient is a coefficient which is calculated using a weight of each edge connecting elements which have been subjected to causal analysis. Specifically, for a direct path, the path coefficient calculation section 205 calculates, as a path coefficient, a weight of an edge constituting the path. For an indirect path, the path coefficient calculation section 205 calculates, as a path coefficient, a product of weights of a plurality of edges constituting the path. Note that the product of weights of edges is merely an example of a path coefficient, and a path coefficient may be calculated by another method. It can be said that a path having a larger path coefficient value is more likely to be a useful path.

The condition satisfaction determination section 206 determines whether or not each of paths detected by the path detection section 203 satisfies a predetermined condition. A condition may be set arbitrarily, and a user may set a condition. For example, the condition may be that a particular element is included, or a condition may be set for an index value to be calculated by the change index calculation section 204, a path coefficient to be calculated by the path coefficient calculation section 205, a cost to be calculated by the cost calculation section 207, or the like. For example, the condition satisfaction determination section 206 may determine that a path whose cost calculated by the cost calculation section 207 is equal to or less than a predetermined threshold value satisfies a condition, and a path which is less than the threshold value does not satisfy the condition.

The cost calculation section 207 calculates, for each path detected by the path detection section 203, a cost that is necessary for changing, by a predetermined amount, a value (a variable of the foregoing target) of an element that serves as an end point of that path. Note that the “cost” includes at least one of a monetary cost, a temporal cost, a human cost, and the like. The cost calculation section 207 may calculate an amount of money, a time, the number of people, or the like, or may calculate an index value indicating a quantity thereof. Thus, the cost calculation section 207 can calculate a cost based on the relationship.

For example, the cost calculation section 207 may first cause the change index calculation section 204 to calculate an amount of change in value of another element necessary for changing, by a predetermined amount, a value of a variable of a target. Then, the cost calculation section 207 may calculate a cost necessary for changing the value of the variable of the target by the calculated amount of change. Note that a cost necessary for changing a value of each variable by a unit amount may be specified in advance.

Further, in a case where a detected path includes three or more elements, a cost may vary depending on which element value is changed. In this case, for example, the cost calculation section 207 may calculate a cost in a case where each element included in the path has been changed. Then, the cost calculation section 207 may set, as a cost of the path, an average value of the calculated costs or a minimum value or maximum value of the calculated costs.

The path information generation section 208 generates, for each of paths detected by the path detection section 203, path information indicating that path. In a case where the path detection section 203 has detected a plurality of paths which share an element serving as an end point, the path information generation section 208 generates path information which indicates each of the plurality of paths in a mode corresponding to that path.

The display control section 209 causes the display section 24 to display path information generated by the path information generation section 208. As described above, the path information indicates a path detected by the path detection section 203. In a case where the path detection section 203 has detected a plurality of paths which share an element serving as an end point, the display control section 209 causes path information to be displayed which indicates each of the plurality of paths in a mode corresponding to that path.

### (Regarding Designation of Element and Detection of Path)

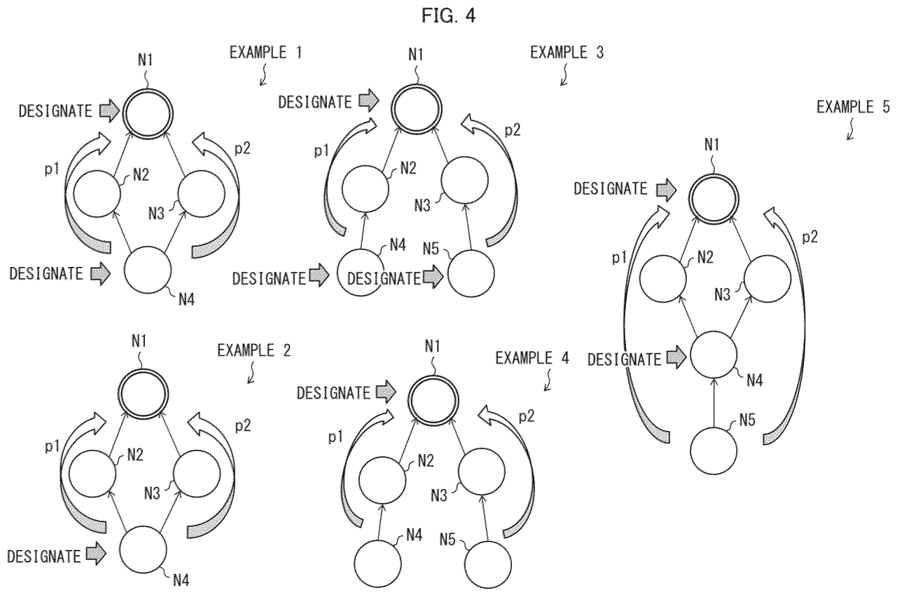

The following description will discuss designation of an element used to detect a path and detection of a path corresponding to a designated element, with reference to FIG. 4. FIG. 4 is a diagram illustrating an example of designation of an element and detection of a path. Note that, in FIG. 4, elements which have been subjected to causal analysis are indicated by circular nodes, and causal relationships between the elements are indicated by directed edges (one-way arrows). FIG. 4 illustrates five examples 1 through 5.

In example 1, from among four elements indicated by nodes N1 through N4, an element of the node N4 is designated as a start point (i.e., the foregoing RCV) of a path, and an element of the node N1 is designated as an end point (i.e., the foregoing target) of the path. Thus, the reception section 201 may receive designation of both an element serving as a start point and an element serving as an end point of a path.

In a case where the reception section 201 has received designation of those elements, the path detection section 203 detects a path in which elements are connected to each other by causal relationships, where the element of the node N4 is a start point and the element of the node N1 is an end point. Specifically, the path detection section 203 detects a path from an element of a start point to an element of an end point by tracing a directed edge along a direction thereof. Note that, in a case where there are branches, the path detection section 203 detects each of the branches as a separate path. In example 1, detected are (i) a path p1 from the element of the node N4 to the element of the node N1 via an element of the node N2 and (ii) a path p2 from the element of the node N4 to the element of the node N1 via an element of the node N3.

Example 2 is an example in which an element of a node N4 is designated as a start point of a path. Thus, the reception section 201 may receive designation of only an element serving as a start point of a path. In this case, the path detection section 203 detects a path in which elements are connected to each other by causal relationships, where the element of the node N4 is a start point. Specifically, in example 2, a path p1 and a path p2 which are identical with those in example 1 are detected.

Example 3 is an example in which an element of a node N4 and an element of a node N5 are designated as start points of paths and an element of a node N1 is designated as an end point of the paths. Thus, the reception section 201 may receive designation of a plurality of elements as start points of paths. In this case, the path detection section 203 detects (i) a path in which elements are connected to each other by causal relationships, where the element of the node N4 is a start point and the element of the node N1 is an end point and (ii) a path in which elements are connected to each other by causal relationships, where the element of the node N5 is a start point and the element of the node N1 is an end point. Specifically, in example 3, detected are (i) a path p1 from the element of the node N4 to the element of the node N1 via an element of a node N2 and (ii) a path p2 from the element of the node N5 to the element of the node N1 via an element of a node N3.

Example 4 is an example in which an element of a node N1 is designated as an end point of a path. Thus, the reception section 201 may receive designation of only an element serving as an end point of a path. In this case, the path detection section 203 detects a path in which elements are connected to each other by causal relationships, where the element of the node N1 is an end point. Specifically, the path detection section 203 detects a path from an element of an end point to an element of a start point by tracing back a directed edge along an opposite direction thereof. In example 4, detected are (i) a path p1 from an element of a node N4 to the element of the node N1 via an element of a node N2 and (ii) a path p2 from an element of a node N5 to the element of the node N1 via an element of a node N3.

Example 5 is an example in which an element of a node N4 is designated as an element included in a path and an element of a node N1 is designated as an end point of the path. Thus, the reception section 201 may receive designation of an element to be included in a path. In this case, the path detection section 203 detects a path which includes the element of the node N4 and in which elements are connected to each other by causal relationships, where the element of the node N1 is an end point. Specifically, the path detection section 203 carries out a process of tracing back a directed edge from a designated element in an opposite direction and a process of tracing the directed edge along a direction thereof, and detects a path which passes through the designated element and reaches an element of an end point. In example 5, detected are (i) a path p1 from an element of a node N5 to the element of the node N1 via the element of the node N4 and an element of a node N2 and (ii) a path p2 from the element of the node N5 to the element of the node N1 via the element of the node N4 and an element of a node N3.

Note that the reception section 201 may receive designation of an indirect element. For example, the reception section 201 may receive designation of a condition to be satisfied by an element included in a path. In this case, the path detection section 203 extracts elements which satisfy a designated condition, and then detects a path including those elements. Examples of the condition include a fact of being (or not being) a direct or indirect cause or result of a designated node, a fact of being located upstream (or downstream) from one or more designated nodes, a combination thereof, and the like.

### (Path Information Display Screen Example 1)

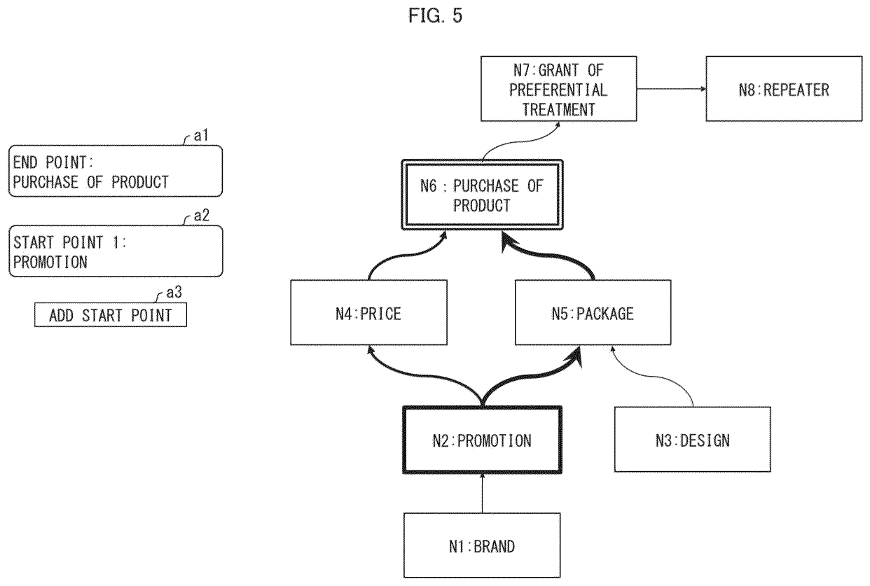

FIG. 5 is a diagram illustrating a path information display screen example. More specifically, FIG. 5 illustrates an example of a display screen in a case where path information is displayed on a causal graph (also called directed acyclic graph) in which a plurality of elements which have been subjected to causal analysis are indicated as nodes and causal relationships between the plurality of elements are indicated by directed edges (one-way arrows). Note that, instead of the directed acyclic graph, it is possible to display a completed partially directed acyclic graph (CPDAG) or an undirected graph.

The causal graph illustrated in FIG. 5 includes nodes N1 through N8. The nodes are connected to each other by directed edges. Among two nodes which are connected to each other by one directed edge, an upstream node (origin side of arrow) indicates a cause, and a downstream node (tip side of arrow) indicates a result. For example, the node N6 and the node N7 are connected to each other by a directed edge which is directed from the node N6 to the node N7. This indicates that an event “purchase of product”, which is an element of the node N6, causes an event “grant of preferential treatment”, which is an element of the node N7.

The display screen illustrated in FIG. 5 includes the causal graph described above and also objects a1 through a3 for receiving input from a user.

The object a1 is an object for receiving designation of an element to be an end point (i.e., the foregoing target) of a path. The user selects the object a1 by input operation via the input section 23, and designates an element to be an end point. For example, in a case where the object a1 has been selected, the display control section 209 may cause a list of elements to be displayed which can serve as end points among elements included in the causal graph, and allow the user to designate an element to be an end point from among the displayed list of elements. In a case where the user has designated an element, as illustrated in FIG. 5, a character string indicating the designated element is displayed in the object a1.

The object a2 is an object for receiving designation of an element to be a start point (i.e., the foregoing RCV) of the path. The user selects the object a2 by input operation via the input section 23, and designates an element to be a start point. For example, in a case where the object a2 has been selected, the display control section 209 may cause a list of elements to be displayed which can serve as start points among elements included in the causal graph, and allow the user to designate an element to be a start point from among the displayed list of elements. In a case where the user has designated an element, as illustrated in FIG. 5, a character string indicating the designated element is displayed in the object a2.

The object a3 is an object for adding an element to be a start point. For example, in a case where the object a3 has been selected, the display control section 209 may cause a list of nodes to be displayed which can serve as start points among elements included in the causal graph, and allow the user to designate an element to be a start point from among the displayed list of elements. In a case where the user has designated an element, a new object indicating the designated element is displayed.

In a case where a node to be an end point and nodes to be one or more start points have been designated as described above, the path detection section 203 detects a path including the designated nodes. In the example illustrated in FIG. 5, “purchase of product”, which is an element of a node N6, is designated as an end point, and “promotion”, which is an element of a node N2, is designated as a start point. In this case, the path detection section 203 detects a path “node N2-node N4-node N6” and a path “node N2-node N5-node N6”.

In a case where a plurality of paths have been detected as described above, the path information generation section 208 generates path information indicating each of the plurality of paths in a mode corresponding to that path, and the display control section 209 causes the path information to be displayed. In the example illustrated in FIG. 5, the display control section 209 displays (i) a contour of a node with double lines at an end point in a detected path, (ii) a contour of a node with thick lines at a start point in the detected path, and (iii) arrows between nodes included in the path also with thick lines. In those manners of display, the detected path is indicated. That is, in FIG. 5, nodes and directed edges displayed in such a display mode are path information.

Here, directed edges in “node N2-node N4-node N6” are different in line thickness from directed edges in “node N2-node N5-node N6”. This difference reflects a difference in detected paths. That is, in FIG. 5, path information is in a display mode corresponding to each path by changing the line thickness of the directed edge.

As described above, the display control section 209 may cause path information to be displayed on a causal graph in which a plurality of elements which have been subjected to causal analysis are indicated as nodes and the causal relationship between the plurality of elements is indicated by a directed edge. Thus, in addition to the example advantage brought about by the information processing apparatus 1 in accordance with the first example embodiment, it is possible to bring about an example advantage of making it possible to allow a user to recognize a relationship between a causal graph and detected path information, that is, a status of the detected path in the causal graph.

Note that a criterion for determining a display mode of path information of each path is not particularly limited. For example, as described in “Regarding display mode of path information” later, a display mode may be decided based on at least one of calculation results and determination results obtained by the change index calculation section 204, the path coefficient calculation section 205, the condition satisfaction determination section 206, and the cost calculation section 207.

The display mode of path information is not particularly limited, provided that each path can be distinguished by the display mode. For example, each path may be distinguished by a form (such as color, thickness, or size of arrow head) of a directed edge. Alternatively, each path may be distinguished by a display mode (such as color, contour line, or size) of a node.

### (Regarding Display Mode of Path Information)

The information processing apparatus 2 includes the change index calculation section 204 that calculates, for each of a plurality of paths which have been detected by the path detection section 203, an index value that indicates a degree of change in variable at an end point of that path in a case where a variable at a start point of that path has been changed. Therefore, the path information generation section 208 can generate path information in a mode corresponding to the calculated index value. Thus, the display control section 209 can cause path information to be displayed in a mode corresponding to the calculated index value.

Therefore, according to the information processing apparatus 2, in addition to the example advantage brought about by the information processing apparatus 1 in accordance with the first example embodiment, it is possible to bring about an example advantage of allowing a user to easily recognize, for each path, a difference in degree of change in variable of an element that serves as an end point in a case where a variable of an element that serves as a start point of that path has been changed.

The information processing apparatus 2 includes the path coefficient calculation section 205 that calculates a path coefficient for each of a plurality of paths which have been detected by the path detection section 203. Therefore, the path information generation section 208 can generate path information in a mode corresponding to a magnitude of the calculated path coefficient. Thus, the display control section 209 can cause path information to be displayed in a mode corresponding to a magnitude of the calculated path coefficient.

Therefore, according to the information processing apparatus 2, in addition to the example advantage brought about by the information processing apparatus 1 in accordance with the first example embodiment, it is possible to bring about an example advantage of allowing a user to easily recognize a path which has a high path coefficient and which is more likely to be useful.

The path information generation section 208 may generate path information in a mode corresponding to the number of elements included in a detected path. Thus, the display control section 209 can cause path information corresponding to the detected path to be displayed in a mode corresponding to the number of elements included in the detected path. For example, the path information generation section 208 may set a line thickness of a directed edge in the path information to be a thickness proportional to the number of elements included in the path or may make a line thickness of a directed edge different depending on whether or not the number of elements is equal to or greater than a predetermined threshold value.

Therefore, according to the information processing apparatus 2, in addition to the example advantage brought about by the information processing apparatus 1 in accordance with the first example embodiment, it is possible to bring about an example advantage of allowing a user to easily recognize, for each path, a difference in the number of elements included in that path.

The path information generation section 208 may generate path information in a mode that varies depending on whether or not a path satisfies a predetermined condition. Whether or not a path satisfies a predetermined condition is determined by the condition satisfaction determination section 206. Thus, the display control section 209 can cause a path which satisfies a predetermined condition to be displayed such that the path is distinguishable from a path which fails to satisfy the predetermined condition.

Therefore, according to the information processing apparatus 2, in addition to the example advantage brought about by the information processing apparatus 1 in accordance with the first example embodiment, it is possible to bring about an example advantage of allowing a user to easily distinguish between a path which satisfies a predetermined condition and a path which fails to satisfy the predetermined condition.

The information processing apparatus 2 includes the cost calculation section 207 which calculates, for each of a plurality of paths which have been detected by the path detection section 203, a cost that is necessary for changing, by a predetermined amount, a variable of an element that serves as an end point of that path. Therefore, the path information generation section 208 can generate path information in a mode corresponding to a magnitude of the calculated cost. Thus, the display control section 209 can cause path information to be displayed in a mode corresponding to the calculated cost.

Therefore, according to the information processing apparatus 2, in addition to the example advantage brought about by the information processing apparatus 1 in accordance with the first example embodiment, it is possible to bring about an example advantage of allowing a user to easily recognize, for each path, a difference in cost which is necessary for changing, by a predetermined amount, a variable of an element that serves as an end point of that path.

### (Path Information Display Screen Example 2)

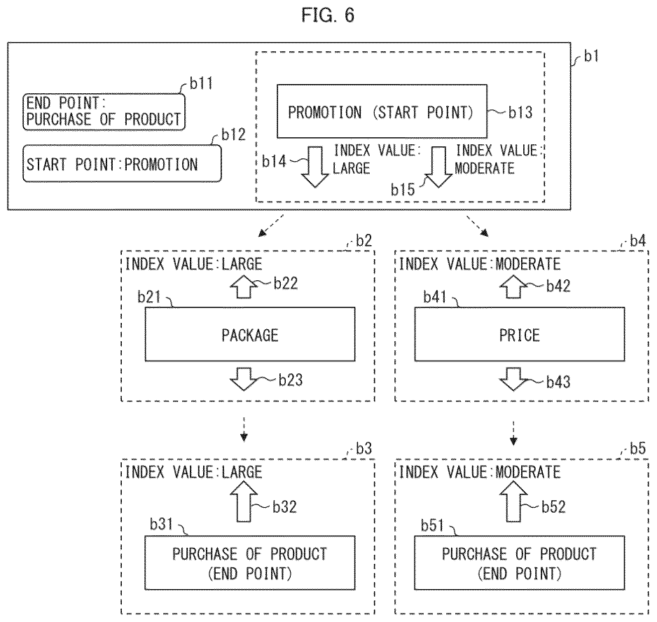

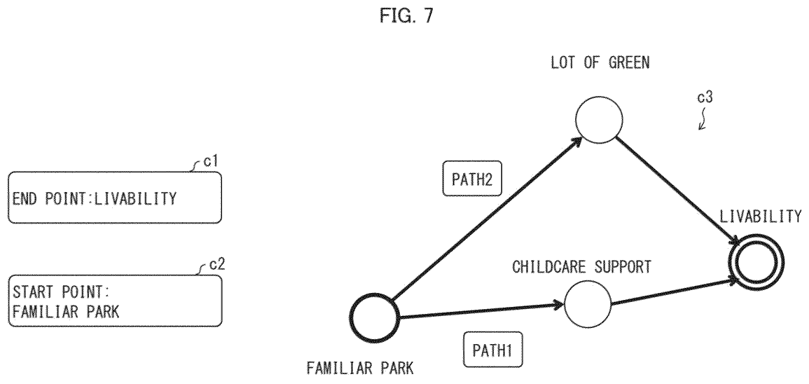

FIG. 6 is a diagram illustrating another path information display screen example. A screen example b1 illustrated in FIG. 6 also includes an object b11 for receiving designation of an element to be an end point and an object b12 for receiving designation of an element to be a start point, which are similar to the objects a1 and a2 in the screen example illustrated in FIG. 4. The screen example b1 includes objects b13 through b15, in addition to the objects b11 and b12. Note that path information in the example illustrated in FIG. 6 is objects and character strings that are displayed in a part surrounded by the broken lines in the screen example b1.

The object b13 is an object which indicates an element of a designated start point and also indicates an element of a start point of a detected path. The object b13 is displayed in association with arrow objects b14 and b15. These objects indicate that there are downstream elements which are connected to the element of the object b13 and also receive input operation for displaying those elements.

The object b14 is associated with a character string which indicates that an index value calculated for a path corresponding to the object b14 is large. The object b15 is associated with a character string which indicates that an index value calculated for a path corresponding to the object b15 is moderate. In a case where user operation to select the object b14 has been carried out, the broken line part in the screen example b1 transitions to b2.

Note that the index value described above is calculated by the change index calculation section 204. Therefore, the path information generation section 208 can classify a magnitude of the index value calculated by the change index calculation section 204 into large, moderate, small, or the like, and generate such path information based on the classification result.

In b2, a character string is displayed which indicates that a path having a large index value is displayed, and objects b21 through b23 are included. Among those, the object b21 indicates that a downstream element connected to an element “promotion” indicated in the object b13 in the screen example b1 is “package”. The object b22 is an object for displaying an upstream element connected to the object b21. Therefore, in a case where user operation to select the object b22 has been carried out, a display state returns to the screen example b1. Meanwhile, the object b23 is an object for displaying a downstream element connected to the object b21. Therefore, in a case where user operation to select the object b23 has been carried out, the broken line part in the screen example b1 is transitioned to a display state of b3.

In b3, objects b31 and b32 are included. Among those, the object 321 indicates that a downstream element connected to the element “package” in the object b21 indicated in b2 is “purchase of product”. Moreover, the object b31 indicates that the element is an object designated as an end point. The object b32 is an object for displaying an upstream element connected to the object b31. Therefore, in a case where user operation to select the object b31 has been carried out, a display state returns to b2.

Meanwhile, in the screen example b1, in a case where user operation to select the object b15 has been carried out, the broken line part in the screen example b1 transitions to b4. The display content of b4 is substantially the same as that of b2, except for the following points: that is, an object b41 of b4 indicates an element “price”; and a character string is displayed which indicates that a path in which a magnitude of an index value is moderate is displayed.

In a case where user operation to select an object b42 has been carried out while b4 is displayed, a display state returns to the screen example b1. In a case where user operation to select an object b43 has been carried out while b4 is displayed, the broken line part in the screen example b1 is transitioned to a display state of b5. The display content of b5 is substantially the same as that of b3 but is different from b3 in that a character string is displayed which indicates that a path in which a magnitude of an index value is moderate is displayed in b5.

Thus, the display control section 209 does not necessarily need to display all elements of the detected path at once, and may cause each of the elements to be displayed individually in response to user operation or the like. Moreover, in causing components of each path to be displayed, as in the example illustrated in FIG. 6, the display control section 209 may cause a character string to be displayed which represents a feature of that path so as to make a display mode of path information different.

### (Path Information Display Screen Example 3)

FIG. 7 is a diagram illustrating still another path information display screen example. A screen example illustrated in FIG. 7 also includes an object c1 for receiving designation of an element to be an end point and an object c2 for receiving designation of an element to be a start point, which are similar to the objects a1 and a2 in the screen example illustrated in FIG. 4. The screen example illustrated in FIG. 7 includes path information c3, in addition to the objects c1 and c2.

The path information c3 indicates a path with nodes and directed edges, as with a causal graph. Specifically, the path information c3 indicates (i) a path 1 from an element “familiar park” to reach “livability” via an element “childcare support” and (ii) a path 2 from the element “familiar park” to reach “livability” via an element “lot of green”.

In the path information c3, a distance between nodes (in other words, a length of a directed edge) is a distance corresponding to a predicted time until a change in upstream element is reflected in a downstream element. That is, in the path information c3, each of the detected paths is displayed in a mode corresponding to a propagation time of a change in that path. Therefore, it can be said that a shortest route indicated in the path information c3 indicates a path with which it can be expected that an effect will be exhibited at the earliest. Thus, the user can intuitively recognize, from among a plurality of paths, a path with which an early effect can be expected.

For example, a distance from an element “familiar park” to an element “childcare support” in the path 1 is shorter than a distance from the element “familiar park” to an element “lot of green” in the path 2. This indicates that, after measures to enrich “familiar park” have been taken, a time until an effect of the measures is reflected as an enrichment level of “childcare support” is shorter than a time until the number of people who feel “lot of green” increases.

Note that the predicted time above indicates a temporal cost in the path, and is calculated by the cost calculation section 207. Therefore, the path information generation section 208 can determine a distance between nodes based on the cost, that is, the predicted time, calculated by the cost calculation section 207 and generate such path information. The path information generation section 208 can generate similar path information based on a cost other than time.

### (Path Information Display Screen Example 4)

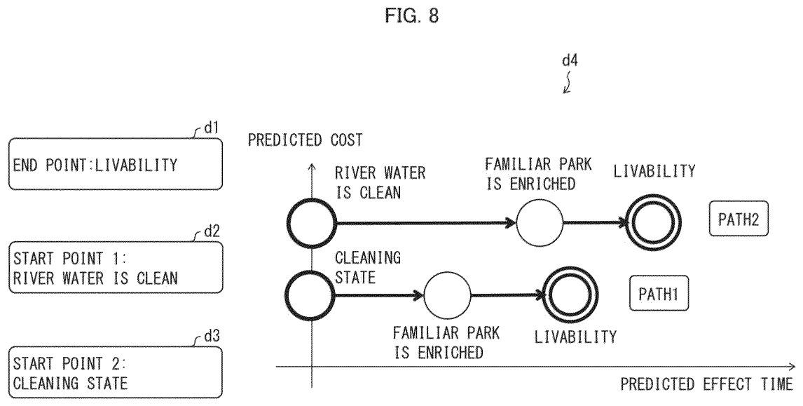

FIG. 8 is a diagram illustrating yet another path information display screen example. A screen example illustrated in FIG. 8 also includes an object d1 for receiving designation of an element to be an end point, which is similar to the object a1 in the screen example illustrated in FIG. 4. The screen example illustrated in FIG. 8 includes objects d2 and d3 and path information d4, in addition to the object d1.

The objects d2 and d3 are objects for receiving designation of an element to be a start point and also indicating designated elements. That is, in the example illustrated in FIG. 8, it is assumed that two elements have been designated as start points.

The path information d4 indicates a path with nodes and directed edges, as with a causal graph. Specifically, the path information d4 indicates (i) a path 1 from an element “cleaning state” to “livability” via an element “familiar park is enriched” and (ii) a path 2 from an element “river water is clean” to “livability” via the element “familiar park is enriched”.

In the path information d4, nodes corresponding to the above elements are displayed on a coordinate plane in which the vertical axis is a predicted cost and the horizontal axis is a predicted effect time. That is, in the path information d4, a vertical position of each of the paths indicates a cost which is predicted to be necessary for that path to improve, by a predetermined amount, the element “livability” of the end point. In the example illustrated in FIG. 8, it can be seen that the predicted cost of the path 2 is approximately twice that of the path 1. Note that the cost in “predicted cost” in FIG. 8 is a monetary cost, and is calculated by the cost calculation section 207.

Moreover, in the path information d4, the horizontal distance between nodes indicates a predicted time until a change in an element corresponding to an upstream node is reflected in an element corresponding to a downstream node. Note that the predicted time is also calculated by the cost calculation section 207.

For example, in the example illustrated in FIG. 8, the horizontal distance from an element “river water is clean” to an element “familiar park is enriched” is longer than the horizontal distance from an element “cleaning state” to the element “familiar park is enriched”. This indicates that a time from when measures to increase the number of people who feel that “river water is clean” have been taken to when an effect of the measures is reflected as an increase in the number of people who feel that “familiar park is enriched” is longer than a time from when measures to improve “cleaning state” have been taken to when an effect of the measures is reflected as an increase in the number of people who feel that “familiar park is enriched”.

Thus, the path information generation section 208 may generate path information in which a plurality of evaluation axes related to each of paths or constituent elements thereof are set and each of the paths is displayed on the evaluation axes. The display control section 209 may cause the path information to be displayed. Thus, it is possible to allow a user to easily recognize a plurality of features of each path. Note that any evaluation axis may be arbitrarily set, and the evaluation axis is not limited to the example illustrated in FIG. 8. For example, the path information generation section 208 may set an evaluation axis for an index value which is calculated by the change index calculation section 204.

### (Flow of Analysis Assistance Method)

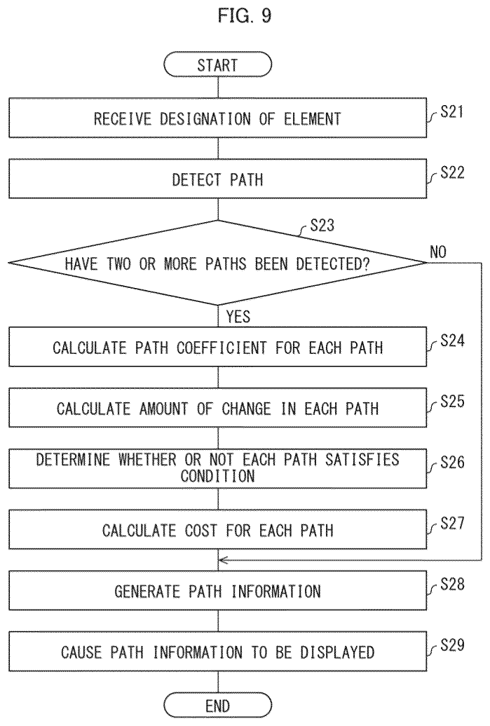

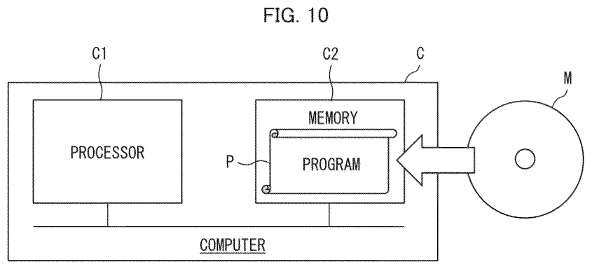

The following description will discuss a flow of an analysis assistance method in accordance with the present example embodiment, with reference to FIG. 9. FIG. 9 is a flowchart illustrating the flow of the analysis assistance method. Note that FIG. 9 illustrates a process in a state where causal analysis by the causal analysis section 202 has been completed and causal relationships between a plurality of elements have been identified.

In S21, the reception section 201 receives designation of at least one element from among a plurality of elements which have been subjected to causal analysis. In receiving designation of an element, the display control section 209 may display a list of the plurality of elements which have been subjected to causal analysis. In this case, the reception section 201 receives designation of an element intended by a user from among the elements indicated in the list.

In S22, the path detection section 203 detects a path including the element designated in S21, from among paths each constituted by a plurality of elements that are connected to each other by a causal relationship. In S23, the path detection section 203 determines whether or not a plurality paths have been detected. In a case where it has been determined to be YES in S23, the process proceeds to S24.

Meanwhile, in a case where it has been determined to be NO in S23, the process proceeds to S28 without carrying out the processes in S24 through S27. In this case, in S28, the path information generation section 208 generates path information indicating a single path detected in S22. Note that, in a case where it has been determined to be YES in S23, the processes in S24 through S27 may be carried out. In this case, even in a case where a single path has been detected in S22, the path information generation section 208 generates path information which indicates the path in a mode corresponding to a result of the processes in S24 through S27.

In S24, the path coefficient calculation section 205 calculates a path coefficient for each of the plurality of paths which have been detected in S22. Note that a weight value used for calculation of the path coefficient can be calculated by a known causal inference or causal discovery method.

In S25, the change index calculation section 204 calculates, for each of the plurality of paths which have been detected in S22, an amount of change in value of an element at an end point of that path in a case where a value of an element at a start point of that path has been changed. Here, the amount of change is calculated as an index value which indicates a degree of change in value of the element. For calculation of the amount of change, the path coefficient calculated in S24 is used. Note that, as described above, the index value indicating the degree of change is not limited to the amount of change, and may be a rate of change or the like. section 206 determines, for each of the plurality of paths which have been detected in S22, whether or not that path satisfies a predetermined condition.

In S27, the cost calculation section 207 calculates, for each of the plurality of paths which have been detected in S22, a cost that is necessary for changing, by a predetermined amount, a value of an element that serves as an end point of that path. Note that an order in which the processes of S24 through S27 are carried out may be set arbitrarily, and it is also possible to carry out some or all of these processes in parallel. It is not always necessary to carry out all of the processes of S24 through S27, and only a part of these processes may be carried out.

In S28, the path information generation section 208 generates path information which indicates each of the paths in a mode corresponding to that path, based on results of the processes in S24 through S27. Note that the path information generation section 208 does not necessarily need to use all of the results of the processes in S24 through S27. For example, the path information generation section 208 may generate path information based on some or all of the results in S24 through S27, in accordance with designation by the user. For example, the path information generation section 208 may generate a plurality of types of path information based on the results of the processes in S24 through S27.

In S29, the display control section 209 causes the display section 24 to display path information generated in S28. Thus, the process of FIG. 9 ends. Note that, as described above, a plurality of pieces of path information may be generated in S28. In a case where a plurality of pieces of path information have been generated, the display control section 209 may cause the plurality of pieces of path information to be displayed. The display control section 209 may switch path information to be displayed in accordance with user operation.

### Variation

Each of the processes described in the above example embodiments may be carried out by an arbitrary execution subject, and the execution subject is not limited to the above-described example. That is, the functions of the information processing apparatuses 1 and 2 can be implemented by a plurality of apparatuses (also referred to as processors) which can communicate with each other. For example, the processes described in the flowcharts of FIG. 2 and FIG. 9 can be carried out by the plurality of processors in a shared manner. That is, an execution subject of the analysis assistance method in the above described example embodiments may be a single processor or a plurality of processors.

### Software Implementation Example

Some or all of the functions of each of the information processing apparatuses 1 and 2 may be implemented by hardware such as an integrated circuit (IC chip), or may be implemented by software.

In the latter case, each of the information processing apparatuses 1 and 2 is implemented by, for example, a computer that executes instructions of a program that is software implementing the foregoing functions. FIG. 10 illustrates an example of such a computer (hereinafter, referred to as “computer C”). The computer C includes at least one processor C1 and at least one memory C2. The memory C2 stores a program (analysis assistance program) P for causing the computer C to operate as the information processing apparatus 1 or 2. In the computer C, the processor C1 reads the program P from the memory C2 and executes the program P, so that the functions of the information processing apparatus 1 or 2 are implemented.

As the processor C1, for example, it is possible to use a central processing unit (CPU), a graphic processing unit (GPU), a digital signal processor (DSP), a micro processing unit (MPU), a floating point number processing unit (FPU), a physics processing unit (PPU), a tensor processing unit (TPU), a quantum processor, a microcontroller, or a combination of these. Examples of the memory C2 include a flash memory, a hard disk drive (HDD), a solid state drive (SSD), and a combination thereof.

Note that the computer C can further include a random access memory (RAM) in which the program P is loaded when the program P is executed and in which various kinds of data are temporarily stored. The computer C can further include a communication interface for carrying out transmission and reception of data with other apparatuses. The computer C can further include an input-output interface for connecting input-output apparatuses such as a keyboard, a mouse, a display and a printer.

The program P can be stored in a computer C-readable, non-transitory, and tangible storage medium M. The storage medium M can be, for example, a tape, a disk, a card, a semiconductor memory, a programmable logic circuit, or the like. The computer C can obtain the program P via the storage medium M. The program P can be transmitted via a transmission medium. The transmission medium can be, for example, a communication network, a broadcast wave, or the like. The computer C can obtain the program P also via such a transmission medium.

### Additional Remark 1

The present invention is not limited to the foregoing example embodiments, but may be altered in various ways by a skilled person within the scope of the claims. For example, the present invention also encompasses, in its technical scope, any example embodiment derived by appropriately combining technical means disclosed in the foregoing example embodiments.

### Additional Remark 2

Some or all of the foregoing example embodiments can also be described as below. Note, however, that the present invention is not limited to the following supplementary notes.

### Supplementary Note 1

An information processing apparatus, including: a reception means for receiving designation of at least one element from among a plurality of elements which have been subjected to causal analysis; a path detection means for detecting a path including a designated element from among paths each constituted by a plurality of elements that are connected to each other by a causal relationship; and a display control means for causing, in a case where the path detection means has detected a plurality of paths which share an element serving as an end point, path information to be displayed which indicates each of the plurality of paths in a mode corresponding to that path.

### Supplementary Note 2

The information processing apparatus according to supplementary note 1, in which: the display control means causes the path information to be displayed on a causal graph in which the plurality of elements are indicated as nodes and the causal relationship between the plurality of elements is indicated by a directed edge.

### Supplementary Note 3

The information processing apparatus according to supplementary note 1 or 2, further including: a change index calculation means for calculating an index value for each of the plurality of paths which have been detected by the path detection means, the index value indicating a degree of change in a value of an element that serves as an end point of that path in a case where a value of an element that serves as a start point of that path has been changed, the display control means causing the path information to be displayed in a mode corresponding to the index value that indicates a degree of change.

### Supplementary Note 4

The information processing apparatus according to any one of supplementary notes 1 through 3, further including:
a path coefficient calculation means for calculating a path coefficient for each of the plurality of paths which have been detected by the path detection means, the display control means causing the path information to be displayed in a mode corresponding to a magnitude of the path coefficient.

### Supplementary Note 5

The information processing apparatus according to any one of supplementary notes 1 through 4, in which: the display control means causes path information corresponding to a path to be displayed in a mode corresponding to the number of elements included in the path.

### Supplementary Note 6

The information processing apparatus according to any one of supplementary notes 1 through 5, in which: the display control means causes a path which satisfies a predetermined condition to be displayed such that the path is distinguishable from a path which fails to satisfy the predetermined condition.

### Supplementary Note 7

The information processing apparatus according to any one of supplementary notes 1 through 6, further including: a cost calculation means for calculating a cost for each of the plurality of paths which have been detected by the path detection means, the cost being necessary for changing, by a predetermined amount, a value of an element that serves as an end point of that path, the display control means causing the path information to be displayed in a mode corresponding to the cost.

### Supplementary Note 8

An analysis assistance method, including: receiving, by at least one processor, designation of at least one element from among a plurality of elements which have been subjected to causal analysis; detecting, by the at least one processor, a path including a designated element from among paths each constituted by a plurality of elements that are connected to each other by a causal relationship; and causing, by the at least one processor, path information to be displayed in a case where a plurality of paths which share an element serving as an end point have been detected, the path information indicating each of the plurality of paths in a mode corresponding to that path.

### Supplementary Note 9

An analysis assistance program for causing a computer to function as: a reception means for receiving designation of at least one element from among a plurality of elements which have been subjected to causal analysis; a path detection means for detecting a path including a designated element from among paths each constituted by a plurality of elements that are connected to each other by a causal relationship; and a display control means for causing, in a case where the path detection means has detected a plurality of paths which share an element serving as an end point, path information to be displayed which indicates each of the plurality of paths in a mode corresponding to that path.

### Additional Remark 3

Furthermore, some of or all of the foregoing example embodiments can also be expressed as below. An information processing apparatus including at least one processor, the at least one processor carrying out: a process of receiving designation of at least one element from among a plurality of elements which have been subjected to causal analysis; a process of detecting a path including a designated element from among paths each constituted by a plurality of elements that are connected to each other by a causal relationship; and a process of causing, in a case where a plurality of paths which share an element serving as an end point have been detected, path information to be displayed which indicates each of the plurality of paths in a mode corresponding to that path.

Note that the information processing apparatus may further include a memory. The memory may store a program for causing the at least one processor to carry out the process of receiving designation of an element, the process of detecting a path, and the process of causing path information to be displayed. The program can be stored in a computer-readable non-transitory tangible storage medium.

### REFERENCE SIGNS LIST

1: Information processing apparatus
11: Reception section (reception means)
12: Path detection section (path detection means)
13: Display control section (display control means)
2: Information processing apparatus
201: Reception section (reception means)
203: Path detection section (path detection means)
204: Change index calculation section (change index calculation means)
205: Path coefficient calculation section (path coefficient calculation means)
207: Cost calculation section (cost calculation means)
209: Display control section (display control means)

What is claimed is:

1. An information processing apparatus, comprising at least one processor, the at least one processor carrying out:
a reception process of receiving designation of at least one element from among a plurality of elements which have been subjected to causal analysis;
a path detection process of detecting a path including a designated element from among paths each constituted by a plurality of elements that are connected to each other by a causal relationship; and
a display control process of causing, in a case where a plurality of paths which share an element serving as an end point have been detected in the path detection process, path information to be displayed which indicates each of the plurality of paths in a mode corresponding to that path.

2. The information processing apparatus according to claim 1, wherein:
in the display control process, the at least one processor causes the path information to be displayed on a causal graph in which the plurality of elements are indicated as nodes and the causal relationship between the plurality of elements is indicated by a directed edge.

3. The information processing apparatus according to claim 1, wherein:
the at least one processor further carries out a change index calculation process of calculating an index value for each of the plurality of paths which have been detected in the path detection process, the index value indicating a degree of change in a value of an element that serves as an end point of that path in a case where a value of an element that serves as a start point of that path has been changed; and
in the display control process, the at least one processor causes the path information to be displayed in a mode corresponding to the index value that indicates a degree of change.

4. The information processing apparatus according to claim 1, wherein:
the at least one processor further carries out a path coefficient calculation process of calculating a path coefficient for each of the plurality of paths which have been detected in the path detection process; and
in the display control process, the at least one processor causes the path information to be displayed in a mode corresponding to a magnitude of the path coefficient.

5. The information processing apparatus according to claim 1, wherein:
in the display control process, the at least one processor means causes path information corresponding to a path to be displayed in a mode corresponding to the number of elements included in the path.

6. The information processing apparatus according to claim 1, wherein:
in the display control process, the at least one processor causes a path which satisfies a predetermined condition to be displayed such that the path is distinguishable from a path which fails to satisfy the predetermined condition.

7. The information processing apparatus according to claim 1, wherein the at least one processor further carries out a cost calculation process of calculating a cost for each of the plurality of paths which have been detected in the path detection process, the cost being necessary for changing, by a predetermined amount, a value of an element that serves as an end point of that path; and
in the display control process, the at least one processor causes the path information to be displayed in a mode corresponding to the cost.

8. An analysis assistance method, comprising:
receiving, by at least one processor, designation of at least one element from among a plurality of elements which have been subjected to causal analysis;
detecting, by the at least one processor, a path including a designated element from among paths each constituted by a plurality of elements that are connected to each other by a causal relationship; and
causing, by the at least one processor, path information to be displayed in a case where a plurality of paths which share an element serving as an end point have been detected, the path information indicating each of the plurality of paths in a mode corresponding to that path.

9. A computer-readable non-transitory storage medium storing an analysis assistance program for causing a computer to carry out:
a reception process of receiving designation of at least one element from among a plurality of elements which have been subjected to causal analysis;
a path detection process of detecting a path including a designated element from among paths each constituted by a plurality of elements that are connected to each other by a causal relationship; and
a display control process of causing, in a case where a plurality of paths which share an element serving as an end point have been detected in the path detection process, path information to be displayed which indicates each of the plurality of paths in a mode corresponding to that path.
